(19) United States
(12) Patent Application Publication
(10) Pub. No.: US 2003/0151782 A1
(43) Pub. Date: Aug. 14, 2003

(54) Image reading apparatus and image forming apparatus

(75) Inventor: Koichi Watanabe, Kawasaki-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/068,901

(22) Filed: Feb. 11, 2002

(51) Int. Cl. H04N 1/46

(52) U.S. Cl. 358/539; 358/505

(57) ABSTRACT

With respect to a scanner function of reading an image on an original, subjecting read image data to JPEG encoding, and storing the resultant data in a hard disk drive, when the image is read, a pre-process for the JPEG encoding is performed to quickly store the image data in the hard disk drive, and at the same time the pre-processed image data is read out of the hard disk drive, subjected to a post-process of the JPEG encoding and stored in the hard disk drive.

### BACKGROUND OF THE INVENTION

The present invention relates to an image reading apparatus for optically reading an image on an original by means of a scanner, and to an image forming apparatus such as a digital copying machine, which forms an image based on image data read by the image reading apparatus.

In the prior art, image data read by a scanner is temporarily stored in an image memory as RGB (Red, Green, Blue) signals. A CPU reads out the RGB image data that is temporarily stored in the image memory, and subjects the read-out data to a JPEG encoding process. The resultant data is stored in a hard disk drive (HDD).

Specifically, in the prior art, after a JPEG (Joint Photographic Experts Group) encoding process for one original is completed, an image on the next original is scanned by the scanner and temporarily stored in the image memory. Then, the RGB image data of the original temporarily stored in this image memory is read out and subjected to the JPEG encoding process, and the resultant image data is stored in the hard disk drive (HDD). In this manner, reading operations are successively performed for originals one by one, and images on the originals are scanned.

Accordingly, the completion of reading/inputting of all originals is concurrent with the completion of the JPEG encoding process. In this case, since time is needed for the JPEG encoding process, the scanner is occupied until the completion of the reading/inputting of all originals. Consequently, the user is unable to take away the originals, and the apparatus cannot efficiently be used.

### BRIEF SUMMARY OF THE INVENTION

The object of the present invention is to provide an image reading apparatus and an image forming apparatus capable of reducing an original reading/inputting time and efficiently using the apparatus.

In order to achieve the object, there is provided an image reading apparatus comprising: a feed section which feeds originals one by one; a reading section which reads an image on an original fed from the feed section; a storage section which stores image data read by the reading section; a first control section which executes a control to feed the next original from the feed section, when the image data of the original has been stored in the storage section; and a second control section which executes a control to read out the image data from the storage section and subject the read-out data to an encoding process, in parallel with the control by the first control section, and to store a result of the encoding process in the storage section.

There is also provided an image forming apparatus which reads an image on an original to form an image, comprising: a selection section which selects one of an image forming mode and an image reading mode, which are executed by the image forming apparatus; a reading section which reads an image on an original; a conversion section which converts, when the image forming mode has been selected by the selection section, RGB signals read by the reading section as image data to YMC signals; a fixed-length encoding section which converts the image data of the YMC signals converted by the conversion section to fixed-length codes; a first control section which executes, when the image reading mode has been selected by the selection section, a control to convert RGB signals read by the reading section as image data to YCbCr signals, and executes a control to subject the Cb and Cr signals of the converted YCbCr signals to a sub-sampling process using the fixed-length encoding section; a storage section which stores image data of the YCbCr signals controlled by the first control section; and a second control section which executes a control to read out the image data from the storage section and subject the read-out data to a JPEG encoding process, and to store a result of the JPEG encoding process in the storage section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a schematic structure of an image forming apparatus according to the present invention;

FIG. 2 schematically shows an internal structure of the image forming apparatus;

FIG. 3 shows a schematic structure of processing blocks and illustrates a data flow;

FIG. 4 shows a process sequence in the prior art;

FIG. 5 shows a positional relationship between the components of RGB signals of 4×4 pixels which are image data;

FIG. 6 shows a positional relationship between the components (4:4:4 format) after color conversion to a YCbCr space;

FIG. 7 shows a positional relationship between the components (4:2:2 format) with a resolution reduced to ½ in the main scan direction;

FIG. 8 shows a positional relationship between the components (4:2:2 format) with a resolution reduced to ½ in the sub-scan direction;

FIG. 9 shows a positional relationship between the components (4:1:1 format) with a resolution reduced to ½ in the main scan direction and sub-scan direction;

FIG. 10 shows a process flow from the image reading to the transmission of JPEG-encoded data in the present invention;

FIG. 11 shows an example of the structure of a fixed-length encoding section;

FIG. 12 shows a process sequence of the present invention and a process sequence in the prior art; and

FIG. 13 shows a process flow from the image reading to the transmission of JPEG-encoded data according to another embodiment of the present invention.

### DETAILED DESCRIPTION OF THE INVENTION

An embodiment of the present invention will now be described with reference to the accompanying drawings.

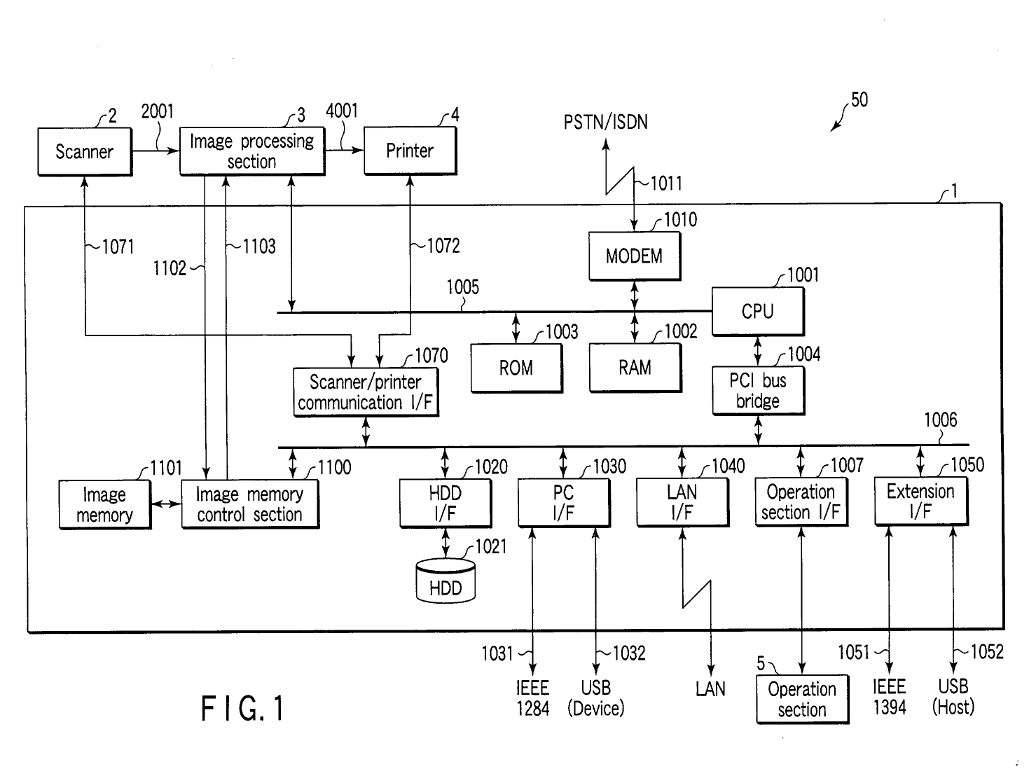

FIG. 1 shows a schematic structure of an image forming apparatus 50 such as a digital color copying machine, which forms a color copy image according to the present invention. Specifically, the image forming apparatus 50 comprises a system control section 1, a scanner 2, an image processing section 3, a printer 4, and an operation section 5.

The system control section 1 controls the entire system.

The scanner 2 scans an original while radiating light from a light source onto the original, thus reading an image on the original.

The image processing section 3 subjects the image data read by the scanner 2 to processing such as y correction, color conversion, main-scan magnification variation, image separation, processing, area processing, and tone adjustment.

The printer 4 modulates the driving of an LD (laser diode) in accordance with image data, and prints out a corresponding image.

The operation section 5 enables the user to instruct operational setting to the apparatus body, and displays the setting content or state. The operation section 5 comprises a graphical display having a touch panel sensor; numeral keys; a start key; a cancel key; and a state display section.

The image forming apparatus 50 may be used as an independent copying machine. Additionally, the image forming apparatus 50 may be connected to, e.g. a client PC (personal computer) (not shown) via a local connection I/F (IEEE 1284, USB, IEEE 1394, in the Figure), whereby it can be used as a color printer, a color scanner, or a transmitter/receiver of a facsimile.

Similarly, the image forming apparatus 50 can be networked, using LAN connection by Ethernet or WAN connection by modems. Various services can be offered from data servers, file servers, mail servers, WEB servers, DNS servers (not shown), etc., which are networked, though not shown.

Besides, as mentioned above, the image forming apparatus 50 can be used as a color printer, a color scanner, or a facsimile transmission/reception apparatus, on the client PC side.

This apparatus can be monitored or controlled from a remote place (not shown).

The functions of the system control section 1 will now be described.

The system control section 1 is connected to the scanner 2 and printer 4. The system control section 1 controls the operations of the scanner 2 to read color or black-and-white image data, and controls the printer 4 to print out color or black-and-white image data.

In the system control section 1, image data read by the scanner 2 is temporarily stored in the image memory 1101, whereby a necessary number of images can be output from the printer 4 with a single reading operation. Moreover, the system control section 1 can perform an N-in-1 mode in which images on two or more pages are reduced and arranged on a single paper sheet, image rotation which realizes a desired gathering mode with 90° unit rotation, form-synthesis in which a slip format, etc. is formed on read image data, and synthesis of dates, logos, watermarks, etc.

The image data scanned by the scanner 2 is compressed, where necessary, by encoding processes in the image processing section 3 and image memory control section 1100. Thus, after the volume of the data is reduced, images may be accumulated in a hard disk drive (HDD) 1021.

Thereby, an electronic sort mode can be performed, wherein temporarily stored image data can be printed out in a desired order on a desired number of paper sheets.

The system control section 1 can be connected to local connection interfaces, such as an IEEE 1284, a USB and an IEEE 1394, a LAN via a LAN I/F 1040, and a WAN or a telephone network via a modem 1010. Thereby, the apparatus may be used as a color printer wherein an image is generated in response to a print order from a connected device and printed out. It is also used as a color scanner which transfers a read image to a connected device, or as a facsimile receiver/transmitter. Besides, images may be transmitted/received as e-mails.

A plurality of print jobs or images scanned by the scanner 2 may temporarily be stored in the HDD 1021, thereby reconstructing a plurality of files into one file and printing out it.

The structure of the system control section 1 will now be described.

The system control section 1 comprises a RAM 1002, a ROM 1003, a PCI bus bridge 1004, a CPU local bus 1005, a PCI bus 1006, an operation section I/F 1007, a modem 1010, an HDD I/F 1020, a hard disk drive (HDD) 1021, a PC I/F 1030, a LAN I/F 1040, an extension I/F 1050, a scanner/printer communication I/F 1070, an image memory control section 1100, and an image memory 1101 including a page memory and a code memory.

The CPU 1001 is a controller which controls the entire system. The CPU 1001 controls application processes necessary for the image forming apparatus 50, e.g. a printer function, a scanner function, a facsimile function and an e-mail function, an UI (User Interface) process, and data processes such as communication control with local or networked devices, image data format conversion for image data input/output, and encoding.

The RAM 1002 is used as a program memory for process execution by the CPU 1001 or as a data storage area.

The ROM 1003 is used as storage areas for storing boot programs necessary for system startup, programs for realizing various functions of the CPU 1001, and fixed data. Programs and data on the ROM 1003 may be kept therein as compressed data, or may be developed into the RAM 1002 for execution.

The CPU local bus 1005 is a bus for connecting the ROM 1003, RAM 1002 and other peripheral devices to the CPU 1001.

The modem 1010 is a modulation/demodulation device for connection to a public line 1011 such as a PSTN or an ISDN. This enables facsimile transmission/reception, remote connection over telephone lines, and Internet connection via ISPs (Internet Service Provider).

The image processing section 3 is connected to the CPU local bus 1005. The CPU 1001 sets necessary parameters for image processing in the image processing section 3. In addition, attribute information (e.g. black-and-white/color) of scanned image data is acquired by the CPU 1001. The CPU 1001 controls the operation of the image processing section 3.

The host bus of the CPU 1001 is connected to the PCI bus 1006 via the PCI bus bridge 1004. Thus, data transfer is effected between the CPU 1001 and the devices on the CPU local bus 1005, and the devices on the PCI bus 1006.

Depending on the type of the CPU, there may be cases where the CPU host bus is the same as the CPU local bus, or the PCI bus bridge is incorporated in the CPU.

By virtue of the PCI bus 1006 employed, high-speed data transfer can be effected irrespective of the type of the CPU, and conventional devices according to PCI bus standards can be used.

The image memory control section 1100 controls the large-capacity image memory 1101 capable of storing non-compressed image data and compressed image code data. The image memory control section 1100 executes a control to store image data read by the scanner 2 into the image memory 1101, and a control to read out the image data from the image memory 1101 and to deliver it to the printer 4.

The image memory control section 1100 can handle image data of various formats. For example, the image memory control section 1100 can perform input/output processes and rotational processes and has copying functions for rectangular areas and one-dimensional areas, with respect to black-and-white images such as two-value images and multi-value gray-scale images, as well as color images such as non-compressed full-color images and fixed-length code images obtained by encoding and compressing images in units of a rectangular block.

In addition, the image memory control section 1100 has functions of encoding/decoding image data in the image memory 1101 using a reversible variable coding process.

The CPU 1001 can control the image memory control section 1100 and access the image memory 1101 via the PCI bus 1006. Similarly, the other devices on the PCI bus 1006 can access the image memory 1101, thus enabling high-speed data transfer with the HDD 1021 or other external I/F interfaces.

The image data scanned by the scanner 2 is transferred to the image memory control section 1100 through the image processing section 3 and a scanner video I/F 1102.

Image data is transferred from the image memory control section 1100 to the printer 4 via a printer video I/F 1103 and the image processing section 3.

The scanner/printer communication I/F 1070 effects communication with the scanner 2 and printer 4 for command and status control information via serial communications 1071 and 1072. Thereby, it is possible to obtain data on the startup and state of the apparatus, the size and kind of scanned originals, the designated size of sheets, the amount of residual paper or consumable parts, etc.

The HDD I/F 1020 controls the HDD 1021 with an IDE or an SCSI as interface, and effects high-speed data transfer with the RAM 1002 on CPU local bus 1005 and the image memory 1101 on PCI bus 1006 via the PCI bus 1006.

The PC I/F 1030 connects to a PC (Personal Computer), etc. via an IEEE 1284 (1031), which is a parallel I/F, or a USB bus (1032), which is a serial I/F.

The LAN I/F 1040 connects to a LAN 1041 via an Ethernet, an optical fiber, a token ring, etc.

The operation section I/F 1007 connects to the operation section 5. An instruction is sent to the CPU 1001 via the PCI bus 1006, thereby enabling the control of the present apparatus.

The extension I/F 1050 is an external connection interface provided for flexible extension of the image forming apparatus 50 in the future.

The IEEE 1394(1051) is a high-speed serial bus interface for high-speed image data input/output. With connection of a high-performance external controller via the IEEE 1394, high-speed image reading and high-speed image processing can be performed, or a high-speed printer apparatus can be realized.

If a plurality of image forming apparatuses are connected via the IEEE 1394(1051), image data read by one image forming apparatus and image data produced by a print instruction can be printed by the plural image forming apparatuses in a distributed fashion. Thereby, a printing apparatus with a high throughput in total can be realized.

The USB host 1052 is an interface for connection with a USB device. The USB host 1052 enables connection and control of many peripherals designed for PCs.

For example, a reader unit for reading memory cards such as smart media and compact flashes may be connected, and images acquired by digital still cameras can be printed. A CD-ROM drive or a floppy disk drive may be connected, and documents stored in a CD-ROM can be printed or the version of main programs may be updated. Besides, user recognition/authentication can be performed with connection to fingerprint verify units, card readers or Bluetooth.

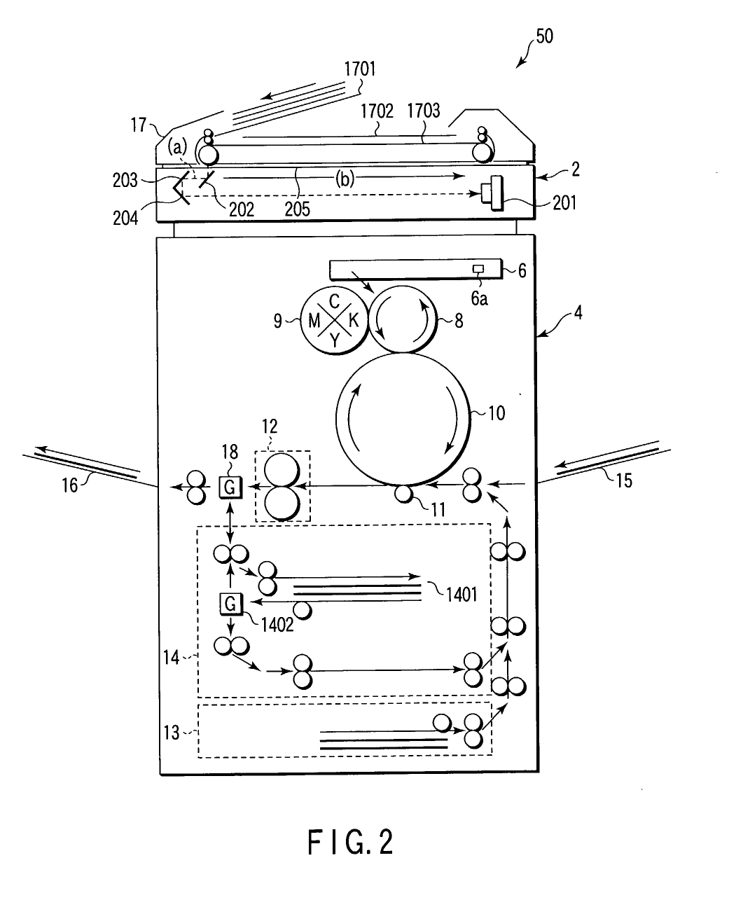

FIG. 2 schematically shows an internal structure of the image forming apparatus 50. In general terms, the image forming apparatus 50 comprises a scanner 2 as image reading means for reading a color image on an original, and a printer 4 as image forming means for forming a copy image of a read color image.

An original table (original scanning table) 205 formed of transparent glass, on which a to-be-read object, i.e. an original, is to be placed, is provided on an upper surface of the scanner 2. An automatic document feeder (ADF) 17 for automatically feeding an original onto the original table 205 is disposed above the scanner 2. The automatic document feeder 17 is disposed to be openable relative to the original table 205. The automatic document feeder 17 functions also as an original holder for holding an original placed on the original table 205 in close contact with the original table 205.

The scanner 2 comprises a color CCD sensor (photoelectric conversion element) 201 for converting reflection light from the original to an electric signal; a first mirror 202, a second mirror 203 and a third mirror 204 for guiding an original image to the color CCD sensor 201; the original table 205; and a light source (not shown), provided near the first mirror, for obtaining reflection light corresponding to read lines on the original.

When the light from the light source (not shown) has been converged on the original on the original table 205, reflection light from the original is made incident on the color CCD sensor 201 via the first mirror 202, second mirror 203 and third mirror 204. The incident light is converted to electric signals corresponding to the three primary colors, R (red), G (green) and B (blue).

The printer 4 comprises an image write section 6 with an LD (laser diode) 6a; a photosensitive drum 8; a developing section 9 for applying toners of respective colors to produce visible images; an intermediate transfer section 10 for retransferring the image formed on the photosensitive drum 8 onto a transfer belt; a transfer section 11 for transferring the image formed on the photosensitive drum 8 onto a transfer paper sheet; a fixing section 12 with a fixing roller and a pressing roller for thermal fixation; a paper feed section 13 for feeding transfer paper; an FIFO automatic double-side unit (ADU) 14; a manual feed section 15; an output section 16; and a convey path switching gate 18.

The automatic document feeder 17 comprises an original placement table 1701, an original output table 1702, and an original feed belt 1703. When an original has been set on the original placement table 1701, the original on the original placement table 1701 is automatically fed and output by the original feed belt 1703. The original is output onto the original output table 1702.

An operation of the image forming apparatus 50 will now be described with reference to FIGS. 1 and 2.

To start with, the CPU 1001 causes the scanner 2 to scan an original with light from the light source (not shown). Reflection light from the original is made incident on the color CCD sensor 201 to read the image. The read image data is delivered to the image processing section 3.

The image processing section 3 subjects the image data to γ correction, color inversion, main-scan magnification variation, image separation, processing, area processing, and tone adjustment. The resultant data is delivered to the image write section 6.

In the image write section 6, the driving of the LD 6a is modulated according to the image data.

Subsequently, a latent image is written by a laser beam from the LD 6a on the rotating photosensitive drum 8 that has been uniformly charged. The developing section 9 applies toner to the latent image to produce a visible image.

The image formed on the photosensitive drum 8 is retransferred on the intermediate transfer belt of the intermediate transfer section 10. In the case of full-color copying, four-color toners (black, cyan, magenta, yellow) are successively applied on the intermediate transfer belt of the intermediate transfer section 10.

In the case of full-color copying, transfer paper is fed from the paper feed section 13 (or manual feed tray 15) in synchronism with the movement of the intermediate transfer belt of intermediate transfer section 10, when the four-color image formation/transfer step has been completed. At the transfer section 11, the four-color toners are transferred at a time onto the transfer paper from the intermediate transfer belt of the intermediate transfer section 10.

In the case of monochromatic copying, one-color (black) toner is transferred from the photosensitive drum 8 onto the transfer belt of intermediate transfer section 10. As with the full-color copying, transfer paper is fed from the paper feed section 13 (or manual feed tray 15) in synchronism with the movement of the intermediate transfer belt of intermediate transfer section 10, when the image formation/transfer step has been completed. At the transfer section 11, the toner is transferred onto the transfer paper from the intermediate transfer belt of the intermediate transfer section 10.

The transfer paper with the transferred toner is sent to the fixing section 12 via a convey section, and is subjected to thermal fixation with the fixing roller and pressing roller of the fixing section 12. The transfer paper is then delivered to the output section 16.

Settings of the copy mode, etc. by the user are input through the operation section 5. The set operation mode, such as the copy mode, is told to the system control section 1. The system control section 1 performs a control process for executing the set copy mode. In this case, the system control section 1 issues control instructions to the respective units, e.g. the scanner 2, image processing section 3, operation section 5, image write section 6, automatic double-side unit 14, and automatic document feeder 17.

An operation of the FIFO automatic double-side unit (ADU) 14 will now be described. In the present apparatus, the ADU 14 has the following three functions.

According to a first function, a paper sheet is turned upside down in order to output the paper sheet in such a state that its fixed-print face, which is directed upward (“face-up”), is turned downward (“face-down”). The paper sheet with fixed printing is delivered toward the ADU 14 by the convey path switching gate 18. As soon as the rear edge of the sheet has passed through the convey path switching gate 18, the direction of conveyance of the sheet is reversed, and delivered to the output section 16. In this case, the sheet is not stacked on a FIFO stack 1401. The output of the “face-down” sheet is necessary in order to match the print faces of sheets with the order of output when originals are successively processed from the first page.

According to a second function, the fixed-print face of each paper sheet is turned upside down and stacked in the ADU 14, and the stacked paper sheets are picked up at a predetermined output timing and delivered onto the output section 16 in the “face-down” state. The paper sheet with fixed printing is delivered toward the ADU 14 by the convey path switching gate 18 and stacked on the FIFO stack 1401. The sheets are successively picked up from the FIFO stack 1401 in the order of stacking (i.e. from the lowermost one) at a predetermined sheet-output timing has come. The picked-up sheets are delivered to the output section 16 in the “face-down” state via convey path switching gates 1402 and 18.

In the present invention, this operation is necessary in the case where a paper sheet, printing on which has been completed prior to a predetermined sheet-output timing in the order of output, is temporarily stacked on the FIFO stack 1401, and the paper sheet is picked up from the stack 1401 and output when the predetermined sheet-output timing has come.

According to a third function, the print surface of a paper sheet is turned upside down for automatic double-side printing, and then the paper sheet is sent back to the transfer section. The sheet with fixed printing is conveyed to the ADU by the convey path switching gate 18 and stacked on the FIFO stack 1401. Immediately after the paper sheet has been stacked, it is picked up and conveyed to the paper-feed convey path by the convey path switching gate 1402. The paper sheet is then sent to the transfer section 11 once again, and printing is effected on the opposite side of the sheet. After an image is transferred on the opposite side of the sheet, the sheet with double-side printing is subjected to fixation in the fixing section 12 and delivered to the output section 16.

In the present invention, the operation of adjusting the order of output of sheets can be achieved by using the circulation path for double-side printing as a stack region, without using the FIFO stack 1401. In this case, however, it is necessary to keep a necessary number of paper sheets in the circulation path.

In the case where the circulation path is used, the FIFO stack 1401 is needless (the turning mechanism for turning the paper being necessary) and the mechanism is simplified. However, a loss of time occurs for repeated passing through the transfer section and fixing section.

A description will now be given of the data flow in the copy function mode and scanner function mode of the image forming apparatus 50 of this invention.

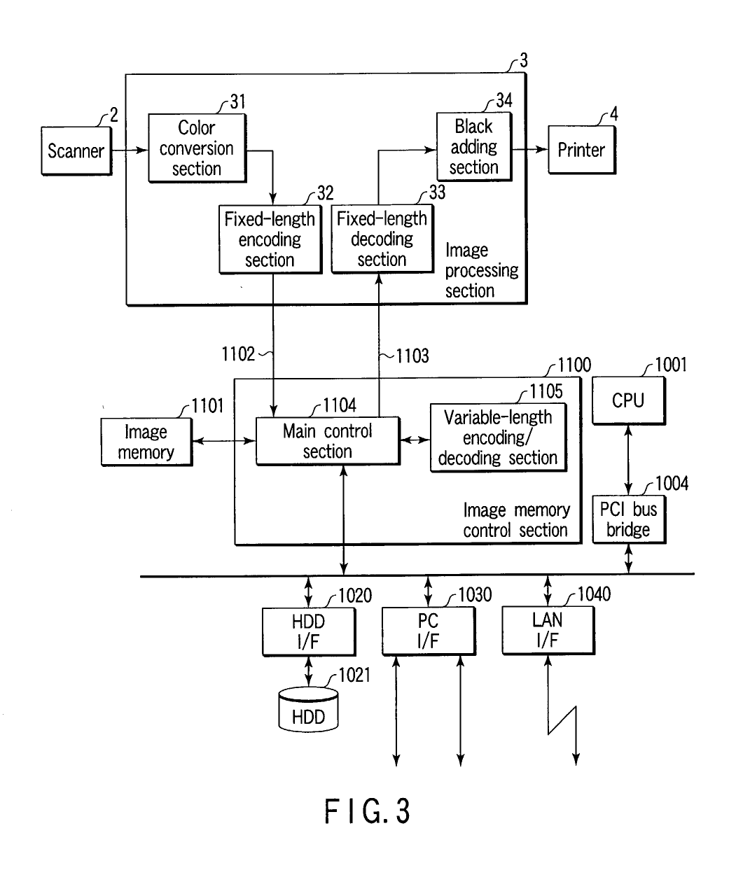

FIG. 3 shows a schematic structure of processing blocks illustrating the data flow.

In FIG. 3, the image processing section 3 comprises a color conversion section 31, a fixed-length encoding section 32, a fixed-length decoding section 33, and a black adding section 34.

Fixed-length encoding methods used in the fixed-length encoding section 32 and fixed-length decoding section 33 are based on encoding methods disclosed in Jpn. Pat. Appln. KOKAI Publication No. 11-69164.

As will be described later in detail, the user selects a copy (image formation) mode or an image read mode through the operation section 5.

When the copy mode has been selected, the color conversion section 31 converts RGB signals representing image data to YMC signals and the fixed-length encoding section 32 converts the YMC signals to fixed-length codes.

When the image read mode has been selected, the color conversion section 31 converts RGB signals representing image data to YCbCr signals and the fixed-length encoding section 32 subjects the Cb and Cr signals of the Y, Cb and Cr signals to a sub-sampling process.

The color image copying operation (copy mode) will first be described.

Image data read by the scanner 2 is input to the image processing section 3 as image data represented by RGB (Red, Green, Blue) signals.

The color conversion section 31 in the image processing section 3 converts the RGB signals to YMC (Yellow, Magenta, Cyan) signals.

The fixed-length encoding section 32 converts the image data represented by the YMC signals to fixed-length codes in units of 2×2 pixels, thereby to reduce the amount of data recorded in the image memory 1101 and to shorten the time for transfer to the HDD 1021.

The image memory control section 1100 comprises a main control section 1104 and a variable-length encoding/decoding section 1105.

The image memory control section 1100 develops the image data in the form of fixed-length codes into the image memory 1101. This image data, which is encoded with the fixed length, is developed with the original image layout.

Moreover, the main control section 1104 of image memory control section 1100 causes the variable-length encoding/decoding section 1105 to variable-length encode the image data that is encoded with the fixed length. The main control section 1104 transfers the resultant data to the HDD 1021 via the HDD I/F 1020. By virtue of the variable-length encoding by the variable-length encoding/decoding section 1105, the time for transfer to the HDD 1021 can be decreased.

As regards the printing of a first copy, the fixed-length-encoded image data developed in the image memory 1101 is subjected, where necessary, to an N-in-1 process or a rotating process, and then the processed data is decoded by the fixed-length decoding section 33 into the original image data of YMC signals.

The black adding section 34 produces Y, M, C and Bk (Yellow, Magenta, Cyan, Black) signals, which are toner colors to be actually used for printing, on the basis of the decoded image data of YMC signals.

In the case of a four-rotation type printer 4 wherein four-color toners are applied in an overlapping manner using the intermediate transfer section 10 shown in FIG. 2, the same fixed-length-encoded image data in the image memory 1101 is read out four times. In each reading-out operation, the black adding section 34 produces Y, M, C and Bk signals and delivers them to the printer 4 for full-color image formation.

In the case of a 4-series tandem type printer having image forming sections for four colors, the fixed-length-encoded image data in the image memory is once read out, and Y, M, C and Bk signals are simultaneously produced by the black adding process and delivered to the printer for full-color image formation. In this case, since the Y, M, C and Bk signals of the read-out data have the same timing, an image data delay memory corresponding to intervals of the four-color image forming sections is required. The image data delay memory may be dispensed with, if data is read out of the image memory four times in accordance with the image producing timing of the four-color image forming sections. In this case, however, there are drawbacks: the rate of read-out transfer from the image memory is increased four times in total, and the scale of the circuit increases due to the four-parallel fixed-length-decoding.

As regards the printing of the second copy and the following, the scan operation by the scanner 2 is not necessary since the image data of all originals has been stored in the HDD 1021.

The image data of necessary pages is read out of the HDD 1021 in a required order by the main control section 1104 of image memory control section 1100. The read-out image data is developed in the image memory 1101, which serves as a page memory, as the image data that has been encoded with fixed length by the variable-length encoding/decoding section 1105.

The fixed-length-encoded image data developed in the image memory 1101 is subjected to an N-in-1 process, a rotating process, etc., where necessary, and the resultant data is decoded to the original image data of YMC signals in the fixed-length decoding section 33.

The black adding section 34 produces Y, M, C and Bk (Yellow, Magenta, Cyan, Black) signals of toner colors used in actual printing, on the basis of the image data of the decoded YMC signals.

In the case of the four-rotation type printer 4 in which four-color toners are overlaid using the intermediate transfer section 10 shown in FIG. 2, the same image data encoded with fixed-length in the image memory 1101 is read out four times. In each reading-out operation, the black adding section 34 produces Y, M, C and Bk signals and delivers them to the printer 4 for full-color image formation.

In the case of the 4-series tandem type printer having image forming sections for four colors, the fixed-length-encoded image data in the image memory is once read out, and Y, M, C and Bk signals are simultaneously produced and delivered to the printer for full-color image formation.

The printing process for the second and following copies is repeated a necessary number of times, thus carrying out the full-color copying operation.

The operation of the color scanner function (image read mode) will now be described.

In the color scanner function, color image data on an original read by the scanner 2 is converted to an ordinary image format and transferred to the PC, etc. externally connected via the external input/output interface, e.g. LAN I/F 1040 or PC I/F 1030. Thus, the image data is utilized.

Ordinary color image data formats include a full-color non-compression image format that represents image data of RGB signals as 24-bit data, or a JPEG format that can achieve a high compression ratio with low image degradation.

In this case, however, the data amount of non-compressed image data is very large, and a great deal of time is needed for image data transfer to the external device via the LAN, etc. Thus, the number of pages to be transferred per unit time is small, and efficient processing cannot be performed.

To cope with this, the high-performance encoding such as JPEG encoding is performed with a level of tolerable image degradation being maintained, thereby greatly reducing the amount of image data and efficiently performing processes.

The conventional color scanner function and JPEG encoding process will now be described.

Image data read by the scanner is input to the image processing section in the form of RGB signals.

In JFIF (JPEG File Interchange Format) known as a general JPEG file format, a color space of Y, Cr and Cb, as defined below, is used.

Thus, the image processing section does not perform a color conversion process or a fixed-length encoding process, and outputs the RGB signals directly to the page memory (image memory).

The page memory (image memory) stores the image data in the form of RGB signals.

The CPU reads out the image data of RGB signals from the image memory, subjects the image data to a JPEG encoding process, and stores the result of the JPEG encoding process in the HDD.

After completing the JPEG encoding process for one page, the scanner scans an image of the next original and stores it in the image memory. Then, the JPEG encoding process is performed for a necessary number of originals.

Accordingly, the completion of the input of all originals concurs with the completion of the JPEG encoding process. In this case, since time is needed for the JPEG encoding process, the scanner is occupied until the completion of the input of all originals. Consequently, the user is unable to take away the originals, and the apparatus cannot efficiently be used.

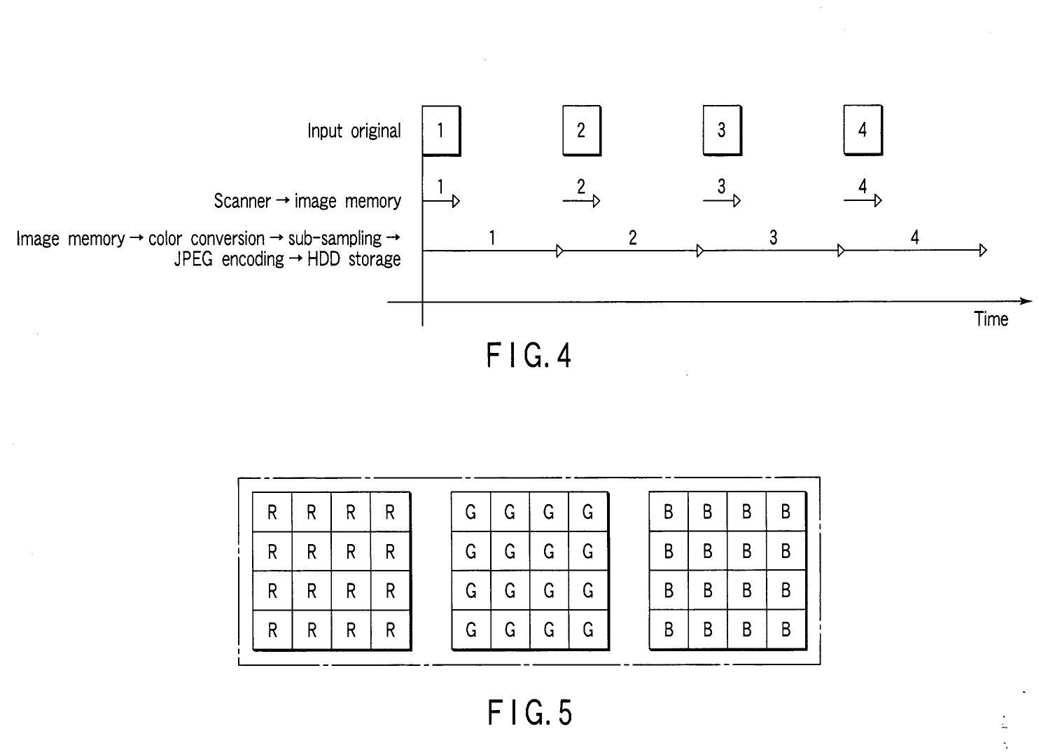

FIG. 4 shows a processing sequence in the above-described prior-art process.

The reading of the original image by the scanner into the image memory is effected by hardware, and so it is completed at the same time as the reading of the original.

The JPEG encoding process of the image data in the image memory is effected by hardware executed by the CPU.

To start with, the CPU performs a color conversion process to convert an RGB space to a YCbCr space.

Subsequently, the CPU sub-samples color difference components (Cb, Cr) of the Y, Cb and Cr signals obtained by the color conversion process.

The CPU subjects the Y, Cb and Cr signals, for which the sub-sampling of color difference components was completed, to the JPEG encoding process, and stores the resultant in the HDD.

The color conversion process from RGB signals to YCbCr signals and the color conversion process from YCbCr signals to RGB signals are expressed by:

RGB to YCbCr Conversion

YCbCr (256 levels) can be computed directly from 8-bit RGB as follows:

Y=0.299R+0.587G+0.114B

Cb=−0.1687R−0.3313G+0.5B+128

Cr=0.5R−0.4187G−0.0813B+128

YCbCr to RGB Conversion

RGB can be computed directly from YCbCr (256 levels) as follows:

R=Y+1.402(Cr−128)

G=Y−0.34414(Cb−128)−0.71414(Cr−128)

B=Y+1.772(Cb−128)

A supplemental description of the sub-sampling process for color difference components will now be given.

It is known that the Cb and Cr signals, which are color difference components, are not so greatly detrimental to the image quality, as the Y signal that is the luminance component, even if the number of pixels is reduced. In common practice, the number of pixels associated with the color difference component is made less than the number of pixels associated with the luminance component (i.e. sub-sampling of the color difference signal).

In the description below, a 4:2:2 (Y:Cb:Cr) format refers to a format wherein the resolution of the color difference signals in the main scan direction or sub-scan direction is reduced to ½, compared to the luminance signal. A 4:1:1 (Y:Cb:Cr) format refers to a format wherein the resolution of the color difference signals in the main scan direction and sub-scan direction is reduced to ½. A 4:4:4 (Y:Cb:Cr) format refers to a format wherein the resolution of the color difference signals is made equal to that of the luminance signal.

FIG. 5 shows a positional relationship between the components of RGB signals of 4×4 pixels which are image data.

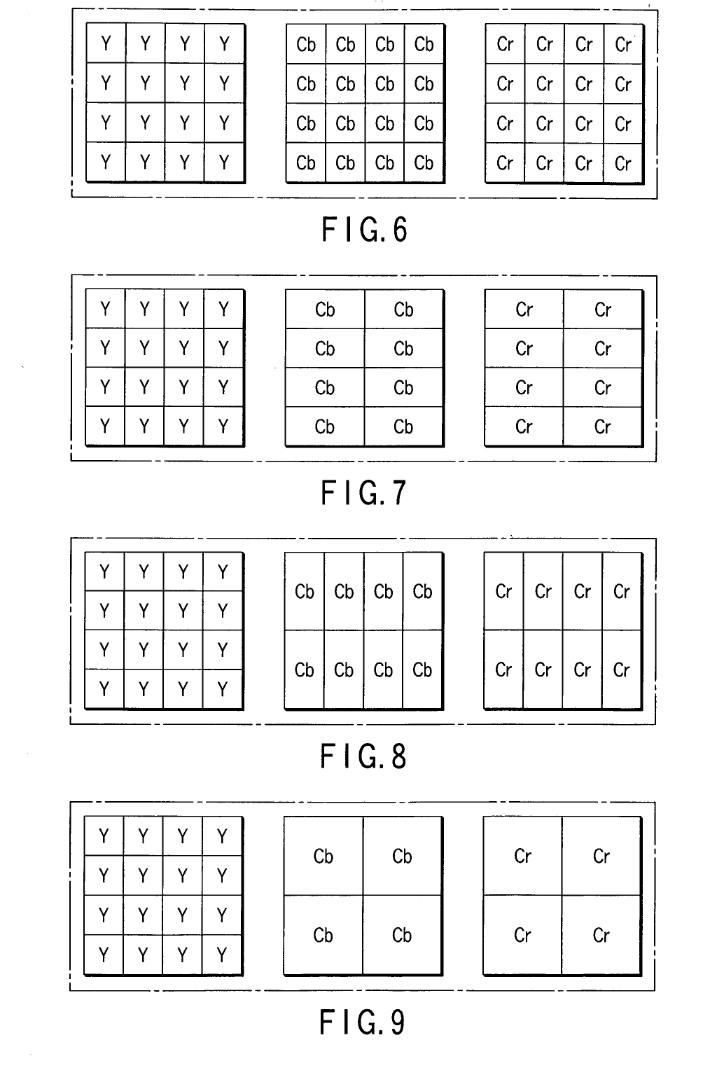

FIG. 6 shows a positional relationship between the components (4:4:4 format) obtained by color-converting the RGB signals of 4×4 pixels to the YCbCr space.

FIG. 7 shows a positional relationship between the components (4:2:2 format) obtained by color-converting the RGB signals of 4×4 pixels to the YCbCr space and reducing the resolution to ½ in the main scan direction.

FIG. 8 shows a positional relationship between the components (4:2:2 format) obtained by color-converting the RGB signals of 4×4 pixels to the YCbCr space and reducing the resolution to ½ in the sub-scan direction.

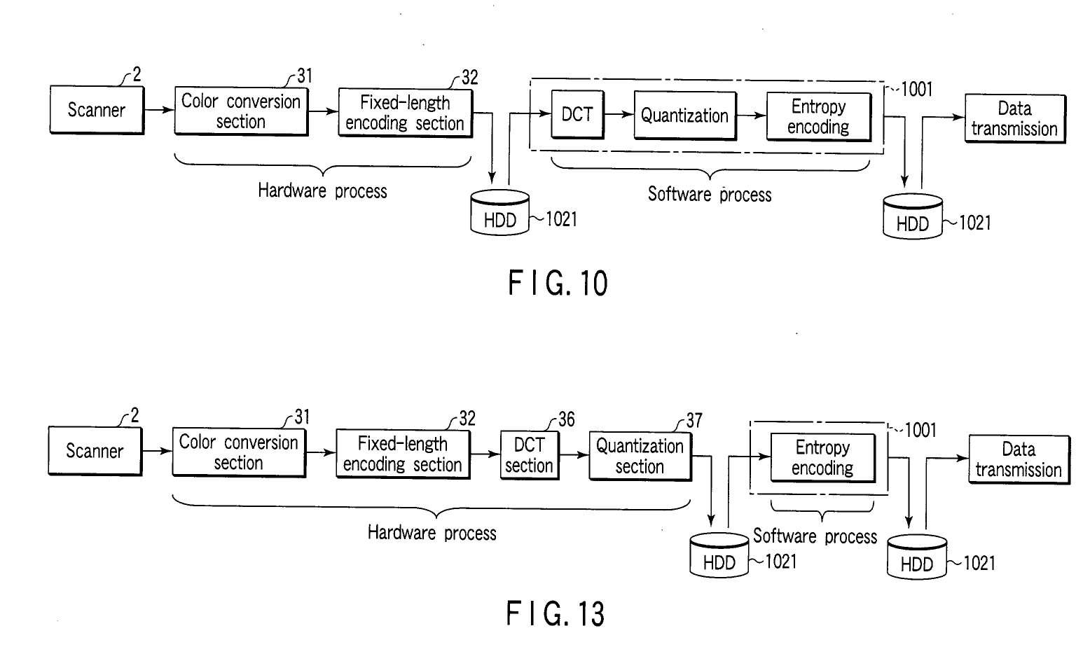

FIG. 9 shows a positional relationship between the components (4:1:1 format) obtained by color-converting the RGB signals of 4×4 pixels to the YCbCr space and reducing the resolution to ½ in both the main scan direction and sub-scan direction.

The color scanner function and the JPEG encoding process according to the present invention will now be described (“image scan mode”).

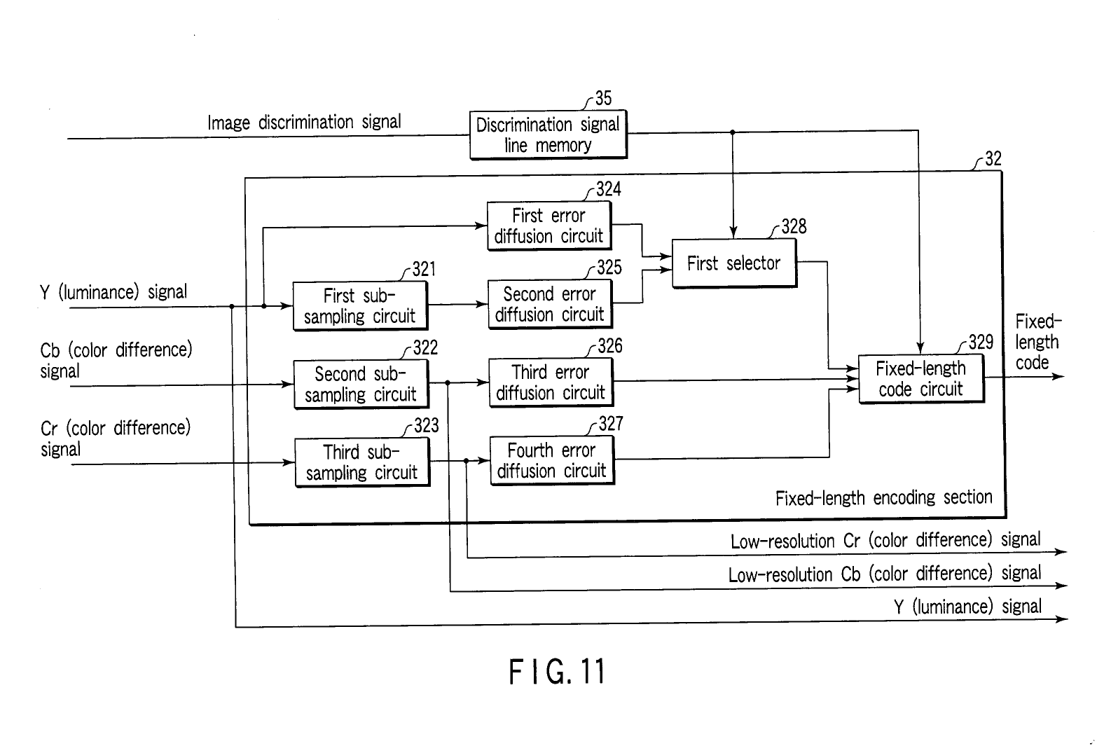

FIG. 10 illustrates a process flow from the image scan to the JPEG encoding and JPEG code data transmission in the present invention. This process flow is a flow of a JPEG encoding process executable by the process scheme shown in FIG. 3.

RGB image data scanned by the scanner 2 is converted to a YCbCr space by the color conversion section 31.

The color conversion process executed by the color conversion section 31 is necessary for converting an RGB space to a YMC space in ordinary copying processes. With substantially the same processing scheme, conversion to a YCbCr space can be performed. Thus, processing circuits can be shared and a color conversion to a YCbCr space can be performed without substantially increasing the number of circuits.

The YCbCr signals (4:4:4 format) are sub-sampled to YCbCr signals (4:2:2 format) or YCbCr signals (4:1:1 format) by color difference signal sub-sampling (fixed-length encoding section 32).

By the sub-sampling of the color difference signals, the image data amount is reduced to ⅔ in the 4:2:2 format, or to ½ in the 4:1:1 format.

The sub-sampling process of color difference signals necessitates no increase in number of circuits, because the sub-sampling circuits of fixed-length encoding section 32 can be shared.

FIG. 11 shows an example of the structure of the fixed-length encoding section 32. The fixed-length encoding section 32 comprises a first sub-sampling circuit 321, a second sub-sampling circuit 322, a third sub-sampling circuit 323, a first error diffusion circuit 324, a second error diffusion circuit 325, a third error diffusion circuit 326, a fourth error diffusion circuit 327, a first selector 328 and a fixed-length code circuit 329.

A Y (luminance) signal input to the fixed-length encoding section 32 is directly output as the Y (luminance) signal. A Cb (color difference) signal is sub-sampled by the second sub-sampling circuit 322 and output as a low-resolution Cb (color difference) signal. A Cr (color difference) signal is sub-sampled by the third sub-sampling circuit 323 and output as a low-resolution Cr (color difference) signal. Thus, sub-sampling is effected in the 4:2:2 format or the 4:1:1 format.

As has been described above, the color conversion and color-difference sub-sampling can be effected by hardware, and thus completed at the same time as the reading by the scanner 2.

At this point of time, the CPU 1001 does not perform the JPEG encoding for the sub-sampled YCbCr signals of the color difference signals, and only effects storage of image data in the HDD 1021 using the image memory 1101 as a buffer memory.

In this case, since the image data amount has been reduced by the sub-sampling of color difference signals (½ in the 4:1:1 format), the time for storage in the HDD 1021 is shortened.

After the image data of the scanned page (one original) has been stored in the HDD 1021, the CPU 1001 repeats the series of operations: scanning of the next page (one original), color conversion, sub-sampling and storage in the HDD 1021. Thus, the image data of all originals is stored in the HDD 1021.

In the present embodiment, the JPEG encoding process is not carried out when the image data is stored in the HDD. Thus, compared to the case of storing the image data in the HDD while performing the JPEG encoding process, the time for storing the image data of all originals in the HDD can be decreased.

Accordingly, the user, who has set a to-be-scanned original, can remove it earlier by the length of time corresponding to a saved time period which, otherwise, would be consumed for storing the image data of the original in the HDD. Thus, the scanner can be set in the free state earlier.

In addition, the CPU 1001 reads out the YCbCr signals at the same time these signals have been stored in the HDD 1021, and starts the JPEG encoding process for the read-out signals.

The CPU 1001 subjects the read-out Y, Cb and Cr signals to software processes of DCT (Discrete Cosine Transform), quantization and entropy encoding. The CPU 1001 adds additional information such as a header for a JPEG file to the processed signals, and stores them as a JPEG file in the HDD 1021.

In the JPEG encoding process executed by the software in the CPU according to the present embodiment, the color conversion and color difference sub-sampling processes have been completed at the time the image data is stored in the HDD. Accordingly, the process time, which, otherwise, would be consumed in the color conversion and color difference sub-sampling processes, can be saved.

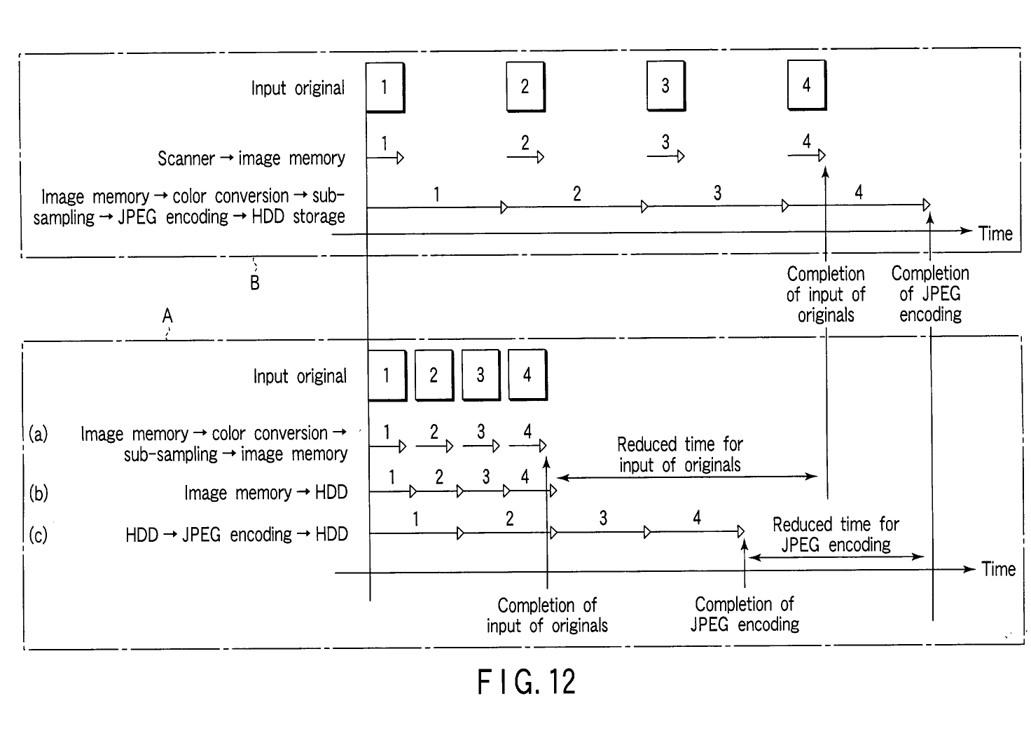

FIG. 12 illustrates a process sequence A of the present invention and a process sequence B of the prior art.

The process sequence A of this invention, as described above, progresses as follows.

(a) The reading of original image data from the scanner 2 into the image memory 1011 is effected by hardware of the image processing section 3, and therefore it is completed at the same time the scanning of the original has been completed (scanner→color conversion→sub-sampling→image memory).

(b) The image data in the image memory 1011 (YCbCr signals obtained by sub-sampling color differences) is transferred to the HDD 1021 (image memory→HDD).

The series of operations from the reading of the original, color conversion, sub-sampling and storage of image data in the HDD 1021 via the image memory, as described in the above (a) and (b), are repeated for each of the originals (in the example of FIG. 12, four originals are input in the order of 1→2→3→4).

In the process sequence A of the present invention, the time needed up to the “Completion of input of originals” can be reduced by “Reduced time for input of originals” in FIG. 12, compared to the prior-art process sequence B.

(c) The image data stored in the HDD 1021 is subjected to the JPEG encoding process by the software of the CPU 1001, and the processed data is stored as a JPEG file in the HDD 1021 (HDD JPEG encoding HDD).

In the process sequence A of the present invention, the time needed up to the “Completion of JPEG encoding” can be reduced by “Reduced time for JPEG encoding” in FIG. 12, compared to the prior-art process sequence B.

Therefore, the time of completion of storage of original image data in the hard disk drive (HDD) is determined by either of the following two times, which is the later: the original scan cycle time by the scanner, and the time needed for transferring 1-page image data to the HDD (varying depending on the transfer performance of the HDD).

FIG. 13 shows a process flow from the image reading to the JPEG code data transmission according to another embodiment of the present invention.

In this embodiment, the hardware process is extended to cover the color conversion section 31, fixed-length encoding section (color difference sub-sampling) 32, DCT section 36 and quantization section 37. Specifically, the DCT section 36 and quantization section 37 are added to the color conversion section 31 and fixed-length encoding section 32 for the hardware processing. In this case, circuits of the DCT section 36 and quantization section 37 have to be added.

Only the entropy encoding is executed by software.

The CPU 1001 executes a software process for the entropy encoding.

In this embodiment, the time for the JPEG encoding process by the software of the CPU can be reduced by a length corresponding to the time, which, otherwise, would be consumed in the color conversion, color difference sub-sampling, DCT and quantization processes.

As has been described above, according to the embodiments of the invention, the process of storing the original image data in the hard disk drive (HDD) and the process of JPEG encoding are separately performed, whereby the time for inputting originals can be decreased.

Moreover, the color conversion process and the color difference signal sub-sampling process are executed by hardware. Thereby, the JPEG encoding process time can be decreased.

Accordingly, the time needed up to the completion of the JPEG encoding process for image data of all originals can be reduced.

Furthermore, the color conversion process, color difference signal sub-sampling process, DCT process and quantization process are executed by hardware. Thereby, the JPEG encoding process time can further be decreased.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image reading apparatus comprising:
a feed section which feeds originals one by one;
a reading section which reads an image on an original fed from the feed section;
a storage section which stores image data read by the reading section;
a first control section which executes a control to feed the next original from the feed section, when the image data of said original has been stored in the storage section; and
a second control section which executes a control to read out the image data from the storage section and subject the read-out data to an encoding process, in parallel with the control by the first control section, and to store a result of the encoding process in the storage section.

2. An image reading apparatus according to claim 1, wherein said storage section is a hard disk drive.

3. An image reading apparatus according to claim 1, wherein the encoding process controlled by the second control section is a JPEG encoding process.

4. An image reading apparatus comprising:
a reading section which reads an image on an original;
a color conversion section which color-converts image data read by the reading section;
a process section which subjects the image data color-converted by the color conversion section to a sub-sampling process;
a storage section which stores the image data subjected to the sub-sampling process in said process section; and
a control section which executes a control to read out the image data from the storage section and subject the read-out data to an encoding process, and to store a result of the encoding process in the storage section.

5. An image reading apparatus according to claim 4, wherein said color conversion section and said process section are hardware processes.

6. An image reading apparatus according to claim 4, wherein the encoding process controlled by the control section is a software process.

7. An image reading apparatus according to claim 4, wherein a sub-sampling factor for the sub-sampling process is selected in said process section.

8. An image reading apparatus comprising:
a reading section which reads an image on an original;
a color conversion section which color-converts image data read by the reading section;
a process section which subjects the image data color-converted by the color conversion section to a sub-sampling process;
a discrete cosine conversion section which subjects the image data sub-sampled by the process section to a discrete cosine conversion process;
a quantization section which quantizes the image data subjected to the discrete cosine conversion process by the discrete cosine conversion section;
a storage section which stores the image data quantized by the quantization section; and
a control section which executes a control to read out the image data from the storage section and subject the read-out data to an entropy encoding process, and to store a result of the entropy encoding process in the storage section.

9. An image forming apparatus which reads an image on an original to form an image, comprising:
a selection section which selects one of an image forming mode and an image reading mode, which are executed by the image forming apparatus;
a reading section which reads an image on an original;
a conversion section which converts, when the image forming mode has been selected by the selection section, RGB signals read by the reading section as image data to YMC signals;
a fixed-length encoding section which converts the image data of the YMC signals converted by the conversion section to fixed-length codes;
a first control section which executes, when the image reading mode has been selected by the selection section, a control to convert RGB signals read by the reading section as image data to YCbCr signals, and executes a control to subject the Cb and Cr signals of the converted YCbCr signals to a sub-sampling process using the fixed-length encoding section;
a storage section which stores image data of the YCbCr signals controlled by the first control section; and
a second control section which executes a control to read out the image data from the storage section and subject the read-out data to a JPEG encoding process, and to store a result of the JPEG encoding process in the storage section.
